(19) United States
(12) Patent Application Publication
(10) Pub. No.: US 2011/0216037 A1
(43) Pub. Date: Sep. 8, 2011

(54) TOUCH SCREEN MODULE STRUCTURE

(75) Inventors: Jin-Goo KANG, Gunpo-si (KR); Dong-Sub KIM, Hwaseong-si (KR); Hak-Yeol KIM, Hwaseong-si (KR)

(73) Assignee: SAMSUNG ELECTRONICS CO. LTD., Suwon-si (KR)

(21) Appl. No.: 13/040,409

(22) Filed: Mar. 4, 2011

(30) Foreign Application Priority Data
Mar. 5, 2010 (KR) 10-2010-0019802

(51) Int. Cl. G06F 3/045; G06F 3/041; G09G 3/36

(52) U.S. Cl. 345/174; 345/173; 345/87

(57) ABSTRACT

A touch screen module structure is provided. The touch screen module structure includes a display unit for displaying image information on a screen, and a touch panel, placed on a screen of the display unit, for recognizing a touch position, wherein the touch panel has a polarization film for decreasing quantity of light introduced from an external source.

### PRIORITY

This application claims the benefit under 35 U.S.C. § 119(a) of a Korean patent application filed in the Korean Intellectual Property Office on Mar. 5, 2010 and assigned Serial No. 10-2010-0019802, the entire disclosure of which is hereby incorporated by reference.

### BACKGROUND OF THE INVENTION

1. Field of the Invention

The present invention relates to a touch screen module structure. More particularly, the present invention relates to a touch screen module structure for improving visibility.

2. Description of the Related Art

A touch screen is a screen equipped with a special input device for receiving an input of a position touched by a user's finger. The touch screen may directly receive input data on the screen without having to use a keyboard in such a manner that when a specific position or a character shown in the screen is touched by a user's finger or an object, the position is detected and is processed by a stored software component. Due to its convenience, the touch screen is used in various fields. The touch screen exhibits its function by attaching a touch panel to a screen of a Liquid Crystal Display (LCD) unit. The touch screen has a function capable of recognizing a position touched by a finger tip or other objects. Therefore, when a character or image data shown on a screen equipped with the touch panel is touched by a finger, an item selected by the user is detected according to a touch position on the screen, and a command corresponding thereto is executed. In this case, information desired by the user may be obtained very easily.

The touch panel may be classified into a pressure-sensitive type and an electrostatic capacity type. In the pressure-sensitive type, a contact point is formed between two conductive layers facing each other by a pressing force, and coordinates are detected according to a signal corresponding to the contact point. In addition, in the electrostatic capacity type, an electric charge (i.e., a flow of current) is charged on a glass surface having a high conductivity, and a position at which the electric charge varies is detected by using a sensor when a contact is made.

In a typical touch screen module structure, an air gap is formed between a touch panel and a screen of a display unit. In this case, light introduced from an external source is reflected from the air gap or layers of other materials, which decreases brightness or contrast of the touch screen. Therefore, a user's ability to read from the display screen becomes worse.

Therefore, a need exists for a touch screen module structure for improving visibility by increasing brightness and contrast by decreasing reflection of light from external sources.

### SUMMARY OF THE INVENTION

An aspect of the present invention is to address at least the above-mentioned problems and/or disadvantages and to provide at least the advantages described below. Accordingly, an aspect of the present invention is to provide a touch screen module structure for improving visibility by increasing brightness and contrast by decreasing reflection of light from external sources.

Another aspect of the present invention is to provide a touch screen module structure for providing good external appearance by allowing a display of a touch screen to be viewed clearly.

In accordance with an aspect of the present invention, a touch screen module structure is provided. The touch screen module structure includes a display unit for displaying image information on a screen, and a touch panel, placed on a screen of the display unit, for recognizing a touch position, wherein the touch panel has a polarization film for decreasing quantity of light introduced from an external source.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following detailed description taken in conjunction with the accompanying drawings, in which:

FIG. 1 illustrates a touch screen module structure according to an exemplary embodiment of the present invention;

FIG. 2 illustrates a touch screen module structure according to an exemplary embodiment of the present invention; and

FIG. 3 is a perspective view of a device using a touch screen module structure according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a”, “an”, and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

An exemplary embodiment of the present invention relates to a touch screen module structure, and, more particularly, to a touch screen module structure for improving visibility and external appearance.

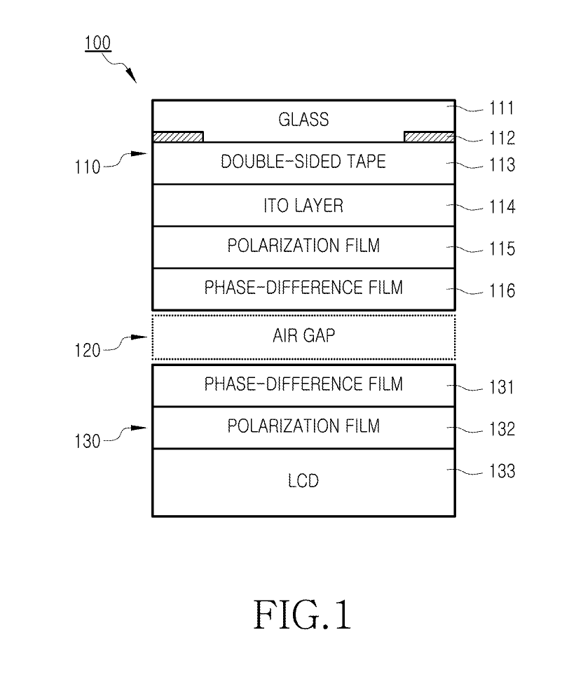

FIGS. 1 through 3, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly state otherwise. A set is defined as a non-empty set including at least one element.

FIG. 1 illustrates a touch screen module structure according to an exemplary embodiment of the present invention.

Referring to FIG. 1, a touch screen module structure 100 includes a touch panel 110 placed on a display unit 130. In this case, an air gap 120 is formed between the touch panel 110 and the display unit 130. The air gap 120 reflects external light, which decreases brightness and contrast of the touch screen module structure thereby decreasing user's visibility.

The touch panel 110 includes a Poly-Carbonate (PC, hereafter referred to as a glass) 111 for providing protection against an external environment and an Indium-Tin Oxide (ITO) layer 114 attached to a lower portion of the glass 111 by means of a double-sided tape 113 to detect a touch. The glass 111 may include a printing area 112 for providing good external appearance. The ITO layer 114 may be either a pressure-sensitive type or an electrostatic capacity type. For example, the pressure-sensitive type ITO layer includes an upper conductive layer and a lower conductive layer which face each other with a specific distance. Herein, a contact point is formed between the two conductive layers by a pressing force, and coordinates are detected according to a signal corresponding to the contact point. In addition, the electrostatic capacity type ITO layer has a glass having a high conductivity. Herein, a position at which the electric charge varies is detected by using a sensor when a contact is made.

Furthermore, the touch panel 110 includes a polarization film 115 and a phase-difference film 116, which are attached to a lower portion of the ITO layer 114 in that order. The polarization film 115 is a film having a property capable of transmitting or blocking incident light by distinguishing a vertical or horizontal fraction of the light, and may regulate quantity of light by transmitting the light only when the light is aligned to a polarization axis. The phase-difference film 116 is a film for avoiding a visual dependence, such as coloring that occurs in a displayed item as a result of optical distortion caused by double refraction or modulation depending on a visual direction. The phase-difference film 116 of the touch panel 110 may be used selectively.

If light introduced from an external source has an omni-directional property, only light aligned to the polarization axis of the polarization film 115 is delivered to the air gap 120 via the phase-difference film 116. That is, light selectively delivered to the air gap 120 is reflected and thus may act as a factor of decreasing visibility, but at the same time, reflected light is less frequently generated to that extent.

The display unit 130 includes a Liquid Crystal Display (LCD) 133 for outputting image information and also includes a polarization film 132 and a phase-difference film 131, which are laminated on an upper portion of the LCD 133 in that order. The LCD 133 is a display unit which uses a polarization phenomenon, and performs an on/off operation in such a manner that a polymer material (i.e., liquid crystal) which changes its direction (or which is rearranged) in response to an electrical signal is inserted between two polarization plates to transmit or block light according to the signal. The liquid crystal requires a light source (i.e., backlight) since it does not emit light but only transmits light according to an applied signal. It is assumed herein that the LCD 133 includes the backlight.

As described above, the polarization film 132 is a film having a property capable of transmitting or blocking the incident light by distinguishing a vertical or horizontal fraction of the light. The light emitted from the backlight of the LCD 133 has the same intensity in all directions. However, the polarization film takes charge of producing polarized light in a specific direction by transmitting only light vibrated in the same direction as the polarization direction while absorbing or reflecting any other light. An arrangement direction of the liquid crystal is electrically regulated for each pixel when the polarized light passes through the liquid crystal of the LCD 133, and thus brightness of the pixel changes. As described above, the phase-difference film is a film for avoiding a visual dependence, such as coloring that occurs in a displayed item as a result of optical distortion caused by double refraction or modulation depending on a visual direction. The phase-difference film 131 of the display unit 130 changes linearly polarized light to circularly polarized light, thereby increasing transmissibility. The phase-difference film 131 of the display unit 130 may be used selectively.

Therefore, when the polarization axis of the phase-difference film 116 of the touch panel 110 is aligned to the polarization axis of the polarization film 132 of the display unit 130, light from the LCD 133 may be emitted without attenuation.

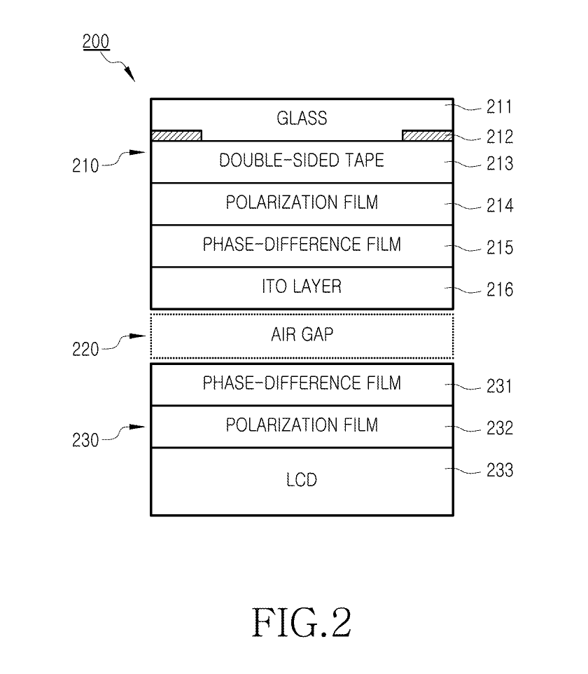

FIG. 2 illustrates a touch screen module structure according to an exemplary embodiment of the present invention.

Referring to FIG. 2, a touch screen module structure 200 includes a display unit 230 and a touch panel 210 placed on the display unit 230. In this case, an air gap 220 is formed between the touch panel 210 and the display unit 230. A description of the air gap 220 and the display unit 230 has been provided above with reference to FIG. 1.

The touch panel 210 includes an ITO layer 216 for generating a signal caused by a touch and also includes a phase-difference film 215, a polarization film 214, a double-sided film 213, and a glass 211 which are laminated on an upper portion of the ITO layer 216 in that order. The glass 211 may include a printing area 212 for providing good external appearance. The ITO layer 216 of the touch panel 210 may be either a pressure-sensitive type or an electrostatic capacity type. However, the electrostatic capacity type may require a higher operating load due to the laminated films. Therefore, the ITO layer 216 may preferably be the electrostatic capacity type.

More particularly, the polarization film and the phase-difference film described in FIG. 1 and FIG. 2 may decrease generation of an LCD noise. Furthermore, when a transparent conductive layer is coated on any one of the films and the transparent conductive layer is connected to a ground portion of a device, the generation of the LCD noise may be further decreased, thereby increasing visibility.

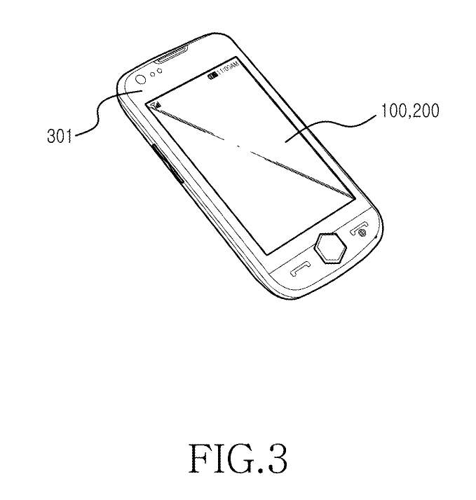

FIG. 3 is a perspective view of a device using a touch screen module structure according to an exemplary embodiment of the present invention.

Referring to FIG. 3, a device has touch screen module structures 100 or 200 of FIGS. 1 and 2, respectively. The touch screen module structures 100 and 200 provide high contrast by decreasing reflected light. This may increase user's visibility and satisfaction. More particularly, the touch screen module structures 100 and 200 may decrease a phenomenon in which a screen looks white due to reflected light even if an LCD is turned off, and thus may increase integrity with a case frame 301 which defines outer surface of the device.

In conclusion, the touch screen module structures 100 and 200 according to exemplary embodiments of the present invention may improve readability and visibility of the touch screen by decreasing introduction of reflected light from an external source. In addition, the touch screen module structures in an exemplary embodiment of the present invention may provide good external appearance by allowing a display of the touch screen to be viewed clearly.

While the invention has been shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. A touch screen module structure comprising:
a display unit for displaying image information on a screen; and
a touch panel, placed on the screen of the display unit, for recognizing a touch position,
wherein the touch panel has a polarization film for decreasing quantity of light introduced from an external source.

2. The touch screen module structure of claim 1, wherein the display unit comprises a Liquid Crystal Display (LCD) unit.

3. The touch screen module structure of claim 1, wherein the touch panel comprises at least one of a pressure-sensitive type and an electrostatic capacity type.

4. The touch screen module structure of claim 1, wherein the polarization film is laminated on the screen of the display unit and has the same polarization axis as the polarization film of the touch panel.

5. The touch screen module structure of claim 4, wherein the display unit comprises a phase-difference film laminated on the polarization film.

6. The touch screen module structure of claim 1, wherein the touch panel comprises an Indium-Tim Oxide (ITO) layer to detect a touch, wherein the polarization film is laminated on a lower portion of the ITO layer.

7. The touch screen module structure of claim 4, wherein the touch panel further comprises a phase-difference film laminated on a lower portion of the polarization film.

8. The touch screen module structure of claim 6, wherein the touch panel further comprises a phase-difference film laminated on a lower portion of the polarization film.

9. The touch screen module structure of claim 6, wherein the touch panel further comprises a glass attached to an upper portion of the ITO layer by means of a double-sided tape to provide protection against an outer environment.

10. The touch screen module structure of claim 1, wherein the touch panel further comprises an ITO layer to detect a touch, wherein the polarization film is laminated by placing a phase-difference film on an upper portion of the ITO layer.

11. The touch screen module structure of claim 10, wherein the touch panel further comprises a glass attached to an upper portion of the polarization film by means of a double-sided tape to provide protection against an outer environment.

12. The touch screen module structure of claim 7, wherein any one of the polarization film and the phase-difference film of the touch panel is coated with a transparent conductive layer and is used as a ground body.

13. The touch screen module structure of claim 10, wherein any one of the polarization film and the phase-difference film of the touch panel is coated with a transparent conductive layer and is used as a ground body.

14. The touch screen module structure of claim 1, wherein the touch panel is disposed on the screen of the display unit by placing an air gap having a specific thickness.

15. The touch screen module structure of claim 5, wherein the phase-difference film of the touch panel may be used selectively.

16. A mobile communication device comprising a touch screen module, the touch screen module comprising:
a touch panel for recognizing a touch position wherein the touch panel has a polarization film for decreasing quantity of light introduced from an external source; and
a display unit for displaying image information on a screen wherein the touch panel is placed on the screen of the display unit.

17. The mobile communication device of claim 16 wherein the touch screen module comprises the display unit comprising a Liquid Crystal Display (LCD) unit.

18. The mobile communication device of claim 16 wherein the touch screen module comprises the touch panel comprising at least one of a pressure-sensitive type and an electrostatic capacity type touch panel.

19. The mobile communication device of claim 16 wherein the touch screen module comprises the polarization film being laminated on the screen of the display unit and having the same polarization axis as the polarization film of the touch panel.

20. The mobile communication device of claim 16 wherein the touch screen module comprises the display unit comprising a phase-difference film laminated on the polarization film.
